(19) United States
(12) Patent Application Publication
(10) Pub. No.: US 2019/0384971 A1
(43) Pub. Date: Dec. 19, 2019

(54) SYSTEM AND METHOD FOR OPTICAL CHARACTER RECOGNITION

(71) Applicant: DOCUVERUS, LLC, Mullica Hill, NJ (US)

(72) Inventor: Jamie Borodin, Mullica Hill, NJ (US)

(73) Assignee: DOCUVERUS, LLC, Mullica Hill, NJ (US)

(21) Appl. No.: 16/438,562

(22) Filed: Jun. 12, 2019

Related U.S. Application Data
(60) Provisional application No. 62/684,299, filed on Jun. 13, 2018.

(51) Int. Cl. G06K 9/00; G06K 9/20

(52) U.S. Cl. CPC G06K 9/00449; G06K 9/2054; G06K 2209/01; G06K 9/00469; G06K 9/00993; G06K 9/00463

(57) ABSTRACT

A system and method based on optical character recognition for verification of uploaded documents, such as proof of income documents, passports, or driver's licenses, among others, using templates and algorithms that provide for determination of the correct context of data scanned from such documents.

### CROSS REFERENCE TO RELATED APPLICATION

This application claims priority from U.S. Provisional Application No. 62/684,299 filed on Jun. 13, 2018.

### FIELD OF THE INVENTION

The field of the instant invention is optical character recognition technology, frequently abbreviated as “OCR,” that is, technology used to convert images of typed, handwritten, or printed text into properly translated machine encoded text for use in electronic data processing environments.

### BACKGROUND OF THE INVENTION

Optical Character Recognition technology is used to scan images and to extract data from images, text, and numbers. Although OCR technology is used to scan such images, extracting meaningful information and the context of the scanned images becomes challenging because traditional OCR technology processes images and text using a fixed line by line approach. In practical terms, while traditional OCR can often read images and alphanumeric text, it has difficulty interpreting the data processed and providing the correct context to the data processed. This failure to take context into account is the problem that the prior art in the OCR field does not solve, but that the instant invention does solve.

### SUMMARY OF THE INVENTION

The instant invention as further described herein encompasses a novel method and set of algorithms for use with OCR technology and is hereinafter referred to from time to time as “Smart OCR,” which method using such algorithms captures data from documents based on customized dynamic virtual templates that maintain the correct context of the scanned data. Smart OCR reads and stores data by scanning for block headers defined in the template and ensures the context of the extracted data is the same as that of the image being scanned. Virtual templates that are designed and managed exclusively by this system are a key part of Smart OCR. This system encompasses templates for, without limitation, state driver licenses, passports, earnings statements, and bank statements. With Smart OCR, data is not just read; it is also correctly interpreted based on the type of image from which it was captured. This correct interpretation is especially useful in, for example, a landlord's verifying employment/wage data produced by a prospective tenant in the form of a recent pay stub uploaded by that applicant, or helping to verify the identity of an applicant by analyzing an identification document (ID) uploaded by an applicant.

A template is effectively a virtual blueprint for a document type, which effectively allows a method of mapping a document. For example, one such template is for a generic earnings statement. That template contains document attributes in standardized locations—attributes such as the block of information about the employee (name and address), the block of information about the employer, the block of information about beginning, ending, or current pay dates, a section on earnings (for the given pay period and for year to date), deductions (statutory, taxable, and non-taxable withholdings), and net pay, among other things. Based on the map of this document type and keywords identified for this specific template, when a user uploads a document matching this format, the matched template maps out where to find each information attribute and instructs the system on how exactly to process the information being read via Smart OCR. In this way, these templates are an important aspect of Smart OCR.

This system of the present invention utilizing Smart OCR recognizes and automatically reads identity, income, and other consumer documents to help automate processes such as verification of identity and verification of income, processes that are done manually in the prior art. Applying traditional OCR to reading complex documents, such as proof of identity or proof of income, simply cannot work; while OCR technology can read words and numbers, prior art technology cannot provide any context to the characters being read. For example, a traditional OCR scanner does not have any ability to understand where exactly a last name appears on a NJ driver's license as opposed to a NY driver's license, or on a passport, nor can it understand where to find pay period gross and net earnings on any kind of standardized proof of income document. Smart OCR solves these problems by translating each document scanned against a template image; once the template is matched using identifiers and header information, among other things, the characters read by Smart OCR result in clear, contextual information which is then presented back to the user.

The system of the instant invention implements a method of fraud detection using a combination of Smart OCR and document orientation and feature analysis. The system compares a presented document against known templates based on the format and design of the standard document, displayed logos (if applicable), indentation and font structure of different sections of the document, numerical calculations, and validation of mandatory document attributes, or in an express use, statutory withholdings (for proof of income documents.

### BRIEF DESCRIPTION OF THE DRAWINGS

FIG. 1 is a flow chart showing the steps of the method of custom template creation for a standard document in the system of the present invention.

FIG. 2 is a flow chart showing the steps of reading and translating data from a representative document uploaded into the system of the present invention.

### DETAILED DESCRIPTION OF THE INVENTION

In the instant invention for use with OCR technology, referred to from time to time as “Smart OCR,” the system and method uses algorithms to capture data from documents based on customized dynamic virtual templates that maintain the correct context of the scanned data. Smart OCR reads and stores data by scanning for block headers defined in a template and ensures the context of the extracted data is the same as that of the image being scanned. This system encompasses templates for, without limitation, state driver licenses, passports, earnings statements, and bank statements.

A template is effectively a virtual blueprint for a standardized document type, which effectively allows a method of mapping a document. For example, one such template is for a generic earnings statement. That template contains document attributes in standardized locations—attributes such as the block of information about the employee (name and address), the block of information about the employer, the block of information about beginning, ending, or current pay dates, a section on earnings (for the given pay period and for year to date), deductions (statutory, taxable, and non-taxable withholdings), and net pay, among other things. Based on the map of this document type and keywords identified for this specific template, when a user uploads a document matching this format, the matched template maps out where to find each information attribute and instructs the system on how exactly to process the information being read via Smart OCR. In this way, these templates are an important aspect of Smart OCR.

This system of the present invention utilizing Smart OCR recognizes and automatically reads identity, income, and other consumer documents to help automate processes such as verification of identity and verification of income, processes that are done manually in the prior art. Applying traditional OCR to reading complex documents, such as proof of identity or proof of income, simply cannot work; while OCR technology can read words and numbers, prior art technology cannot provide any context to the characters being read. For example, a traditional OCR scanner does not have any ability to understand where exactly a last name appears on a NJ driver's license as opposed to a NY driver's license, or on a passport, nor can it understand where to find pay period gross and net earnings on any kind of standardized proof of income document. Smart OCR solves these problems by translating each document scanned against a template image; once the template is matched using identifiers and header information, among other things, the characters read by Smart OCR result in clear, contextual information which is then presented back to the user.

The system of the instant invention implements a method of fraud detection using a combination of Smart OCR and document orientation and feature analysis. The system compares a presented document against known templates based on the format and design of the standard document, displayed logos (if applicable), indentation and font structure of different sections of the document, numerical calculations, and validation of mandatory document attributes, or in an express use, statutory withholdings (for proof of income documents.

In prior art systems, data captured by OCR is based on position mapping. OCR captures data present in place within a document. With traditional OCR, in the event the document uploaded is moved such that the document is skewed or shown in a different scale, OCR fails to capture the correct data. Document movement refers to the fact that some key document attributes could appear in slightly different locations on different documents, even though the documents share the same underlying format, causing failure in a traditional OCR system. The solution of this invention maps and tags document attributes such that even if a given document attribute appears in a different location on a reference document, the system can still process that attribute correctly and with the appropriate context.

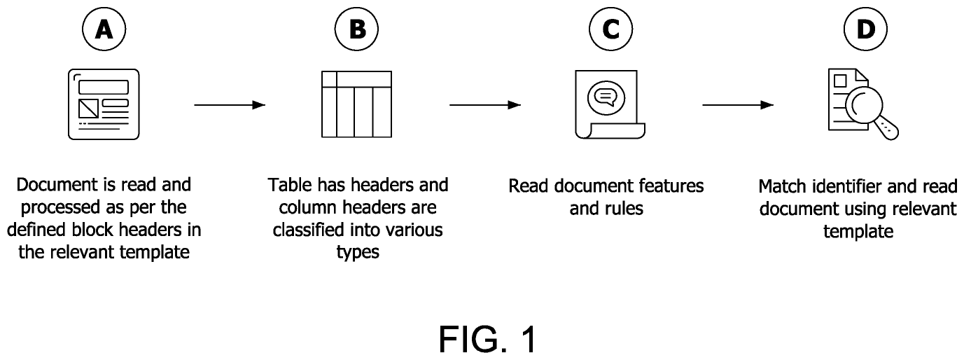

As shown in the flowchart of FIG. 1, the instant system implements Smart OCR technology to identify data and labels that data based on customized, virtual document templates developed in accordance with the steps shown therein. The algorithms used in the present invention do all of the work automatically to build and customize templates, thereby adding new templates to an existing template library.

As in step A of FIG. 1, a new document type is read and processed, being defined as a template in which the system stores all of its table structures and document features. Step B shows that the table structure consists of table headers and column headers; said table headers are classified into various types and said column headers are also classified into various types. In Step C, said new document can also have features such as rules with which the document should be read. Examples of rules include whether or not the document has compressed structure, creating rules to recognize identifiers to identify attribute handling, column sequences, or a data dictionary, to name a representative few examples. At Step D, each document type receives an identifier such that any OCR enforced document can be read using a relevant stored template based on identifier. These identifiers are an important part of the system at issue as these identifiers are used to allow the system to recognize a relevant template to use for processing an uploaded document.

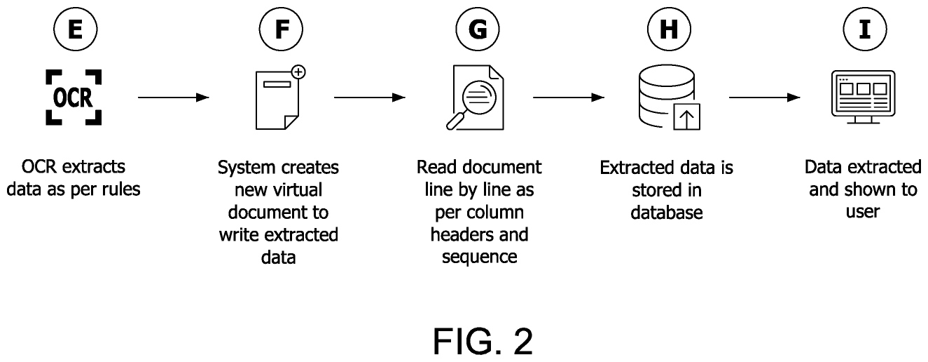

The flowchart of FIG. 2 illustrates the method by which a representative document is scanned for verification using the Smart OCR of the instant system. First, in Step E the system identifies the appropriate template to be used for reading a representative document that has been uploaded into the system, based on matching the document to the correct identifier, as said identifier had been determined in an appropriate Step D. In Step F, the data obtained from said representative document using OCR technology with its respective co-ordinates is used to create a new virtual document having lines of data as in a physical document and said data is written therein after being extracted. As a part of Step F, document rules are used to create said virtual document. In Step G, the Smart OCR system then reads the document line by line, identifying table headers and column headers as per the relevant template. Once such a table is identified, all of its values are stored in its respective tables in a database based on table type as defined in said relevant template and the extracted data is stored in memory in the database shown in Step H, to be accessed on a display screen as shown in Step I, the display being used to verify that the data that is proposed is in fact the actual data as written on a standard form, such as a driver's license or an account statement evidencing wage history of the person proposing such a document as evidence.

Template analysis under the system described hereinabove supports a high level of automatic fraud detection. By using Smart OCR and machine learning to facilitate template comparison, provided documents will automatically be internally compared against standard authentic documents based on attributes of said authentic document that may include: the format and design of a standard authentic document: displayed logos on said standard and authentic documents, including aspects such as logo size, logo color, and relative positioning of logos; indentation and font structure of different sections of the standard authentic document; and numerical validation of calculations and validation of mandatory document attributes or statutory withholdings, if applicable. Based on these attributes, the system at issue generates a document authenticity score that enables the user of the system to determine easily whether the document provided as evidence is or is not authentic. Using the system and method described in this application, fraud detection is quick and simple as it becomes an automatic process.

It should be appreciated that the description of any certain embodiment of the instant invention as set forth herein should not be construed as the sole manner of practicing said invention nor as a limitation on the invention as claimed hereby, coverage of which hereunder shall include the many variations explicitly or implicitly described in this specification.

What is claimed is:

1. A method for the creation of electronic templates for standardized documents that contain data to be read by optical character recognition means comprising the steps of:
uploading a standardized document;
reading and processing said document using defined block headers for columns of data to be stored therein;
classifying said headers;
reading features and rules associated with data to be stored in said columns; and
identifying said document by means of an identifier placed thereon
whereby an electronic template recognized by said identifier is created.

2. The method of claim 1 in which such a standardized document is selected from a group comprising: proof of income documents, driver's licenses, and passports.

3. A system for the creation of electronic templates for standardized documents that contain data to be read by optical character recognition means comprising:
electronic means for uploading a standardized document;
data processing means for reading and processing said uploaded document and
identifying said document by means of an identifier placed thereon; and
memory means,
whereby an electronic template recognized by said identifier is created and stored in said memory means.

4. The system of claim 3 in which said electronic means is a scanning device.

5. The system of claim 3 in which said data processing means is selected from a group comprising:
computing devices, desktop computers, laptop computers, tablets, and smartphones.

6. The system of claim 3 in which such a standardized document is selected from a group comprising: proof of income documents, driver's licenses, and passports.

7. A system for verifying documents comprising:
electronic means for uploading a standardized document and for uploading a document containing data submitted for verification of such data;
data processing means for reading, processing, and identifying said uploaded standardized document by means of an identifier placed thereon and creating a template for said document identified by said identifier;
memory means connected to said data processing means for storing said templates;
optical character recognition software running on said data processing means; and
display means connected to said data processing means,
whereby such a document uploaded and submitted for verification is compared to one of said templates bearing the relevant identifier with the result that the data read by said software is extracted, stored in said memory means, and displayed on said display means for verification of the data contained in said document by a system user.

8. The system of claim 7 in which said electronic means is a scanning device.

9. The system of claim 7 in which a combination of said data processing means, said memory means, and said display means is selected from a group comprising: computing devices, desktop computers, laptop computers, tablets, and smartphones.

10. The system of claim 7 in which such a standardized document is selected from a group comprising: proof of income documents, driver's licenses, and passports.

11. A method for verifying documents comprising the steps of:
uploading a standardized document;
reading and processing said document using defined block headers for columns of data to be stored therein;
classifying said headers;
reading features and rules associated with said data to be stored in said columns;
identifying said document by means of an identifier placed thereon;
creating an electronic template recognized by said identifier;
storing said template;
uploading a document containing data submitted for verification of such data;
identifying the relevant template for verification of such data in said uploaded document;
extracting such data from said uploaded document by optical character recognition means;
creating a virtual document;
writing said data extracted into said virtual document;
reading said data stored in said virtual document;
comparing said data read to said relevant template;
storing the results of said comparison; and
displaying said results for user verification of such data stored in such document submitted for verification.

12. The method of claim 11 in which such a standardized document is selected from a group comprising: proof of income documents, driver's licenses, and passports.

13. In an optical character recognition system, an improvement for verifying documents comprising:
electronic means for uploading a standardized document and for uploading a document containing data submitted for verification of such data;
data processing means for reading and processing said uploaded document, identifying said document means of an identifier placed thereon, and creating a template for said document identified by said identifier;
memory means connected to said data processing means for storing said templates; and
display means connected to said data processing means,
whereby such a document uploaded and submitted for verification is compared to one of said templates bearing the relevant identifier with the result that the data read by system optical character recognition software is extracted, stored in said memory means, and displayed on said display means for verification the data contained in said document by a system user.

14. The improvement of claim 13 in which said electronic means is a scanning device.

15. The improvement of claim 13 in which a combination of said data processing means, said memory means, and said display means is selected from a group comprising: computing devices, desktop computers, laptop computers, tablets, and smartphones.

16. The improvement of claim 13 in which such a standardized document is selected from a group comprising: proof of income documents, driver's licenses, and passports.
